(19) United States
(12) Patent Application Publication
(10) Pub. No.: US 2005/0023237 A1
(43) Pub. Date: Feb. 3, 2005

(54) Detachable plastic bottle and bottle holder for consumers and healthcare

(76) Inventor: Marlon Leslie Inestroza, San Francisco, CA (US)

Correspondence Address: MARLON L. INESTROZA, 3806 22nd Street, San Francisco, CA, 94114, US

(21) Appl. No.: 10/633,455

(22) Filed: Aug. 1, 2003

(51) Int. Cl. B65D 23/00; A47J 41/02

(52) U.S. Cl. 215/12.1

(57) ABSTRACT

A three-piece plastic molded bottle that are detachable by twisting clockwise of a compartment (30), and counterclockwise of the funnel (46). This provides a broader space to put solid contents easily (example ice cubes) into the main body of the bottle (5). The compartment has storage for smaller contents such like medical pills or salad dressing. A healthcare bottle holder has rectangular shapes (90,95) with a wide band (82) to clip on the bed rails. It contains shell shape (77), a base plate (88), and cylindrical knob (96) allowing bottle holder to rotate from 0 to 360 degrees. A consumer bottle holder (109) has a taper shape strap (106) connects with cylindrical pocket (112) allowing a thermo pouch (108) to sit. A mouth-drinking receptacle contains a shaft (56) with two notches (57,58) and five convex grooves,(61,62) connecting to lips surface (70). The spring (76) is surrounded a shaft allowing it to pop up when human lips releases after the lips surface is pressed down.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to plastic drinking bottle, bottle holder, and mouth drinking receptacle for consumers and healthcare patients.

1. Background of the Invention

Drinking bottles come in many shapes, sizes, and colors. Bottles of this type are usually made of such plastics as PET (PolyEthylene Terephthalate), PVC (PolyVinyl Chloride), or HDPE (High Density PolyEthylene) and manufactured using blow or injection molding techniques. Drinking bottles are generally formed with a neck to receive a closure or spout receptacle, a cylindrical wall to hold liquids, and a base shaped to make them easier to hold and more stable when placed on a flat surface. Most plastic drinking bottles are a one-piece unit for storing fluids and are usually disposable for recycling. See the following patents:

| Inventor Name | Patent Number | Date of Patent |
|---|---|---|
| Dolan, J. R. | 1636174 | Jul. 19, 1927 |
| Quinn, J. J. | 2035404 | Mar. 26, 1936 |
| Josephsen, R. C. | 3225950 | Dec. 28, 1965 |
| Reynolds, Raymond G. | D243583 | Mar. 8, 1977 |
| Chang, Long F. | 4294366 | Oct. 13, 1981 |
| Aoki, Katashi | 4465199 | Aug. 14, 1984 |
| Carranza, Jose R. | 4627546 | Dec. 9, 1986 |
| Lane, Michael T. | 5529196 | Jun. 25, 1996 |
| Petre, Jean Marie | 5713480 | Feb. 3, 1998 |
| Bongiorno, Joseph | 5803290 | Sep. 8, 1998 |
| Cheng, Jizu J. | 5988417 | Nov. 23, 1999 |
| Walker, Robert N | D425793 | May 30, 2000 |
| Moore, Shebriniah | D469360 | Jan. 28, 2003 |
| Zhou, Jingliang (CN) | AU760747 | Jan. 18, 2001 |
| MIURA, MASAKI | JP2000062743 | Mar. 5, 2003 |

Holders for bottles generally require screws for mounts or clips on a supporting wall and are designed for specific bottles, usually very large or very small and with irregular shapes such as patent numbers:

| Inventor Name | Patent Number | Date of Patent |
|---|---|---|
| H. Lauzon | D59662 | Nov. 15, 1921 |
| Keyston, D. W. | D171359 | Jan. 26, 1954 |
| Russell Wallace James | 2766900 | Oct. 16, 1956 |
| Schuler, Heriberto | 4379578 | Apr. 12, 1983 |
| Byrns, James E. | 4708254 | Nov. 24, 1987 |
| Varney, James R | D343094 | Jan. 11, 1994 |
| Koday, Yohai | 5839632 | Sep. 22, 1998 |
| Hart, Dorothy Mae | D404132 | Jan. 12, 1999 |
| Peterson, Bruce R | D423774 | May 2, 2000 |
| Giacona III, Corrado | 6443338 | Sep. 3, 2002 |
| Stiz Laurent Aime | FR2801279 | May 25, 2001 |
| Takizawa, Ryuichi | JP2002347773 | Dec. 4, 2002 |
| Takizawa, Kenichi | JP2002104418 | Apr. 10, 2002 |

Most mouth drinking receptacles generally use a twistable or push-pull method for opening and closing and require two hands to operate. See patent numbers below:

| Inventor Name | Patent Number | Date of Patent |
|---|---|---|
| Faulstich, George W. | 4109816 | Aug. 29, 1978 |
| Dolan, Robert L. | 4722448 | Feb. 2, 1988 |
| Darr, Richard C. | 5020692 | Jun. 4, 1991 |
| Proshan, Mary-Elizabeth | 5492253 | Feb. 20, 1996 |
| Miorelli, Graciela | 6502715 | Jan. 7, 2003 |
| Antier Gregory. Damkjaer | FR2827261 | Jan. 17, 2003 |
| McCanns Eng. MFG Co. | GB1415734 | Nov. 11, 1975 |

One-piece plastic bottles are generally not re-used by consumers who see little practical use for them other than drinking liquids and are often recycled after the consumer drinks the liquids sold with them. Manufacturers generally made this bottle from cheap, but recyclable plastics. Consequently, the resulting bottles buckle easily, make noises, and are not looked upon by consumers as something with enough practical use to bother keeping. However, consumers would think otherwise if they had a bottle made of much more durable plastic and which presented far more options for use, such as a wide mouth for adding ice or other bulky substances, in addition to a traditional, but much more functional drinking spout. Consumers wanting ice cold drinks for outings such as hiking, ballgames, working, traveling, taking medications at their convenience, etc. would need only to pour a beverage into the bottle and add ice using the wide mouth. This could be done on the spur of the moment, rather than having to cool the liquid in the bottle beforehand. This would eliminate a plan of preparing freezing water bottle overnight for next day outing. When it happens, a bottle is frozen and must wait to thaw before consuming. Others do not have patience of pouring crushed ice into narrow bottleneck using a teaspoon; one often feel frustrating and give up.

Patients in hospitals and other care facilities often go thirsty due to too few care providers and inability to reach and/or use liquids set out for them. These patients often lack the strength and/or flexibility to get up or reach out for glass water sitting on the nightstand nearby. Nurses often remove pitchers and glasses after sunset leaving no water during evenings. A better solution would be to have a bottle designed to attach to bed rails where it could be easily found by patients and a bottle designed to make it easy for patients to drink.

In general, drinking from a plastic water bottle is a two-hand process, one hand to hold the bottle and the other hand to open the top or spout for drinking. Patients are not alone in the difficulty they can experience trying to open and drink from plastic bottles. Consumers quite often attempt to juggle things in one hand, packages, children, cell phones, etc while at the same time trying to drink from a water bottle with the other hand. A spout designed to open and close with lip action rather than hands would allow patients and consumers far greater flexibility when drinking.

The proposed plastic bottle in this patent application is a three-piece unit that serves various functions and delivers real benefits to consumers and especially hospital patients. It allows consumer to easily add liquids or solid contents, such as ice cubes, by twisting open a funnel (See FIG. 3), then twisting the funnel closed in one easy motion. In addition, a third piece located at the base of the bottle (FIG. 5) that can also be opened and closed by twisting, can be used to store vitamins and pills or capsules which the consumer or patient my want to take when drinking. The detachable plastic bottle can be manufactured in various sizes that would be suitable for all ages and many different uses.

For hands free carrying, the bottle could be placed into a portable thermo cylindrical pocket (FIG. 11) with strap that can be wrapped around the belt or handbag. For hospital patients, the healthcare bottle holder (FIG. 7 and 8) clips onto bed rails. Patients can easily locate the water bottle conveniently in broad daylight or in darkness by reaching a hand toward the bed rail, touching the bottle or bottle holder, and then grabbing the bottle. In the same way, it would be easy for patients to place the water bottle back in the bottle holder.

To facilitate hands free drinking, the detachable bottle has a new mouth receptacle that function like a spring allowing fluids to flow into the mouth from the pressure of lips alone. When the lips are pulled back from the bottle, the receptacle automatically pops up, stopping the flow of fluid.

### BACKGROUND OF INVENTION—OBJECTS AND ADVANTAGES

In addition to the objects and advantages mentioned above several objects and advantages of the present invention are:
a) Detachable bottle can be available in any portable size such as 8 oz., 12 oz., 16 oz., 24 oz., and 33.8 oz.
b) It is cost effective, easy to use, convenient, and serves many purposes
c) The bottles could be packaged for families or other groups, offering a combination of sizes suitable for various uses and types of consumers.
d) The detachable bottle can be used as a shaker to mix drinks or make ice cream floats.
e) The detachable bottle can be used as a funnel to pour liquids from a larger to a smaller container.
f) The detachable bottle can be used for easy pouring of any substance for gardening, flowerpots, restaurants, etc.
g) The detachable bottle can be manufactured in various colors and with various designs and motifs, such as pictures or cartoons, to appeal to children or adults.
h) The detachable bottle can be used for take out salad with salad dressing or fruit salad.
i) The detachable bottle can be used as a personalized lunch box of all ages.
j) The bottom compartment offers a convenient place to store pills and capsules, which requires be taken with liquids or to store salad dressing.
k) The press-down and pop-up mouth receptacle is designed for easy drinking.
l) The bottle holder is portable and can be carried hands free and used conveniently.
m) The bottle holder for patients puts the bottle within easy reach and makes it possible for most to drink without assistance.

### SUMMARY

In accordance with a present invention, a detachable plastic bottle comprises a three-piece cylindrical unit that has a body with inward and outward slopes connecting to neck of a bottle. A bottom base has a detachable compartment whereby unscrewing a piece allowing storing of pills and capsules and attaching it to a bottle. A detachable bottle is designed for personalization, reusable and multi-purpose product for all consumers.

The consumer's bottle holder is generally a plastic material that forms a pocket allowing liquid bottle to sit in to remain cold for as long as possible. It has a strap that can be wrapped over a belt or handbag for hands free carry purpose. A healthcare bottle holder is a plastic material containing a base and shell walls attach to a rectangular wall with a rear wide band. It is design for self-service and convenience to patients. A bottle holder has a band that can snap on to the bed rails giving patients easy access to plastic bottle.

A mouth-drinking receptacle is a plastic material that has an oval shape on top and a cylindrical wall at bottom portion allowing screwing on to the neck of the liquid bottle. A receptacle has a spring force with a twist option to permanently open and close the spout allowing fluids flowing into the mouth. It has a pop-up and press-down feature allowing fluids flowing into mouth by pressing lips onto receptacle and stopping fluids by releasing lips from receptacle.

### DRAWINGS—FIGURES

In the drawings, closely related figures have the same numbers.

FIGS. 1 to 5 illustrate a three-piece detachable plastic bottle. FIG. 6 shows a mouth-drinking receptacle. FIGS. 7 to 11 depict a plastic bottle holder.

FIG. 1 shows an enclosed three-piece detachable plastic bottle in cylindrical shapes combined with external radial horizontal convex grooves, inward and outward slopes, and columns of external vertical convex grooves on the top piece known as Funnel.

FIG. 2 illustrates the standalone body of the detachable bottle form in the cylindrical shapes attached with inward and outward slopes, and two or three horizontal external convex grooves at the top neck of the body. The base bottle shows a line where a small compartment is attached.

FIG. 3 displays a second piece known as the Funnel. It comprises a wide cylindrical shape at a bottom with two or three internal horizontal concave grooves. The top funnel is a narrow cylindrical shape with two external horizontal grooves. Funnel surface comprises columns of external vertical convex grooves.

FIG. 4 illustrates a top piece (Funnel) in 45 degrees angle, and two or three internal horizontal concave grooves.

FIG. 5 shows a compartment and a lid detach from a base of a body.

FIG. 6 shows a mouth-drinking cylindrical shape spout, an elongated tip with a hole, a spring at outer hollow stem, and accordion like material.

FIG. 7 depicts a simple bottle holder. It contains a wide band on back of rectangular wall allowing clipping over bed rails, a base to hold plastic bottle and shell walls to properly hold liquid bottle in a bottle holder.

FIG. 8 illustrates a rotational bottle holder capable of turning bottle holder from 0 to 360 degrees.

FIG. 9 shows an inside of a doughnut hole, external grooves, cylindrical nose, and rectangular walls.

FIG. 10 depicts a consumer bottle holder, and a thermo pouch sitting inside a bottle holder.

FIG. 11 illustrates a combined thermo bag and bottle holder, showing how bottle sits in a bottle holder, and wrap over a belt.

### REFERENCE NUMERALS IN DRAWINGS

| | |
|---|---|
| 1. | Left bottom base curve |
| 2. | Left base side wall |
| 3. | Detach compartment groove |
| 4. | Left body wall |
| 5. | Cylindrical body |
| 6. | Left inward body slope |
| 7. | Left inward body curve |
| 8. | Left body radial outward |
| 9. | Radial |
| 10. | Left inward mid body curve |
| 11. | Left mid body wall |
| 12. | Left outward mid body curve |
| 13. | Mid body external horiz. groove |
| 14. | Left upper body side wall |
| 15. | Upper body external horiz. grooves |
| 16. | Top upper body rim |
| 17. | Right upper body side wall |
| 18. | Right mid body outward curve |
| 19. | Cylindrical mid body |
| 20. | Right mid body side wall |
| 21. | Right mid body side wall |
| 22. | Right mid body inward curve |
| 23. | Right radial end |
| 24. | Right body inward curve |
| 25. | Right mid body inward slope |
| 26. | Right mid body side wall |
| 27. | Right base side wall |
| 28. | Right base curve |
| 29. | Bottle Base |
| 30. | Cylindrical base |
| 31. | Bottom funnel cylindrical |
| 32. | Left funnel side wall |
| 33. | Funnel external vertical grooves |
| 34. | Left corner funnel |
| 35. | Left funnel slope |
| 36. | Left inward funnel neck curve |
| 37. | Left funnel neck wall |
| 38. | External horizontal grooves |
| 39. | Top funnel rim |
| 40. | Funnel neck |
| 41. | Bottle neck external groove |
| 42. | Right funnel neck wall |
| 43. | Right funnel neck inward curve |
| 44. | Right funnel inward slope |
| 45. | Right corner funnel |
| 46. | Cylindrical funnel |
| 47. | Right funnel wall |
| 48. | Internal concave grooves |
| 49. | Cylindrical disc |
| 50. | Tabs |
| 51. | Internal horiz. concave grooves |
| 52. | Vertical cross section grooves |
| 53. | Cylindrical compartment |
| 54. | Internal vertical; groove |
| 55. | Cylindrical base stem |
| 56. | Shaft |
| 57. | Right notch |
| 58. | Left notch |
| 59. | Rectangular hole in shaft |
| 60. | External horizontal groove |
| 61. | External vertical grooves |
| 62. | Receptacle base notch |
| 63. | Closure with concave grooves |
| 64. | Accordion tube |
| 65. | Receptacle base |
| 66. | Right receptacle wall |
| 67. | Left receptacle wall |
| 68. | Top right wall |
| 69. | Top left receptacle wall |
| 70. | Top curve lip surface |
| 71. | Top hole |
| 72. | Vertical grooves |
| 73. | Concave notches |
| 74. | External horizontal groove |
| 75. | Outer cylindrical tube |
| 76. | Spring |
| 77. | Holder section |
| 78. | Left top holder curve |
| 79. | Left bottom holder curve |
| 80. | Right top holder curve |
| 81. | Left top holder curve |
| 82. | Band wall |
| 83. | Right band curve |
| 84. | Left band curve |
| 85. | Band downward slope |
| 86. | Flat band wall |
| 87. | Outward band slope |
| 88. | Base bottle holder |
| 89. | Base holder wall |
| 90. | 1^{st} Rectangular wall |
| 91. | Wedge |
| 92. | Finger curve |
| 93. | Finger tip |
| 94. | Finger |
| 95. | 2^{nd} Rectangular wall |
| 96. | Cylindrical doughnut |
| 97. | Groove wall |
| 98. | Doughnut hole |
| 99. | Concave groove |
| 100. | Cylindrical nose |
| 101. | Nose horiz. grooves |
| 102. | Nose external groove |
| 103. | Snap |
| 104. | Left taper wall |
| 105. | Snap contact |
| 106. | Taper strap |
| 107. | Right taper wall |
| 108. | Thermo pouch |
| 109. | Bottle holder pocket |
| 110. | Left pocket wall |
| 111. | Right pocket wall |
| 112. | Base pocket holder |
| 113. | Top taper strap wall |

### DETAILED DESCRIPTION

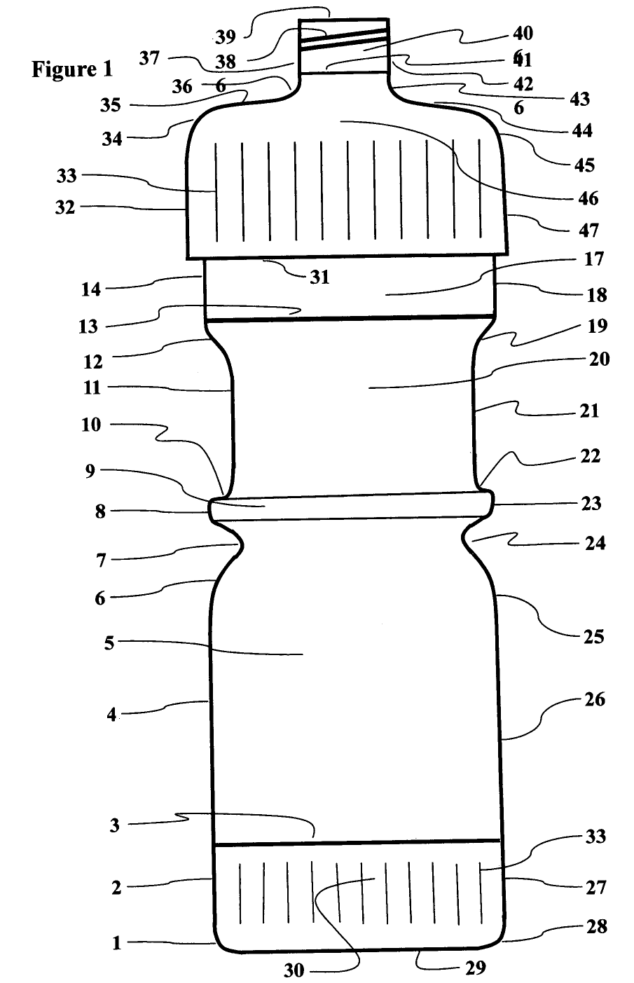

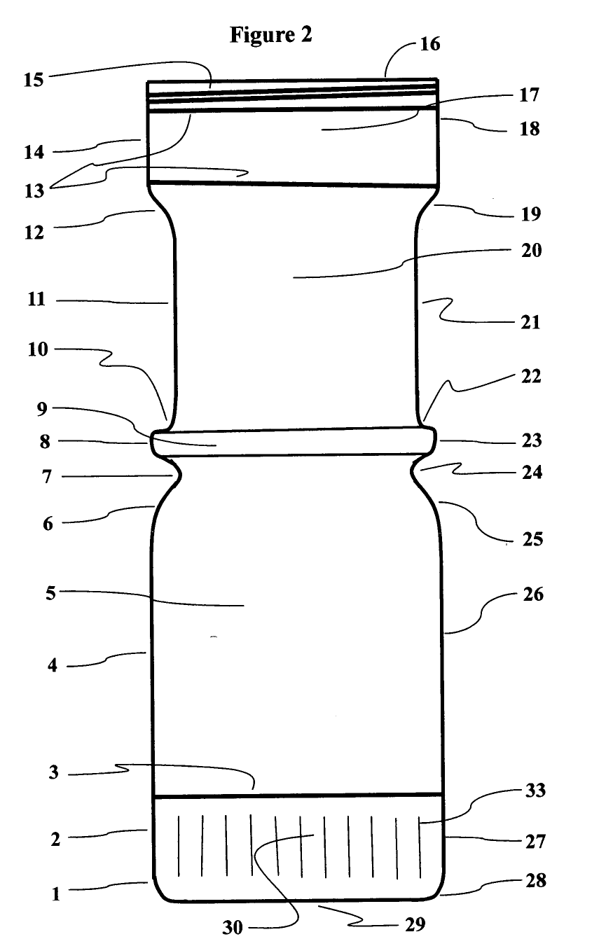

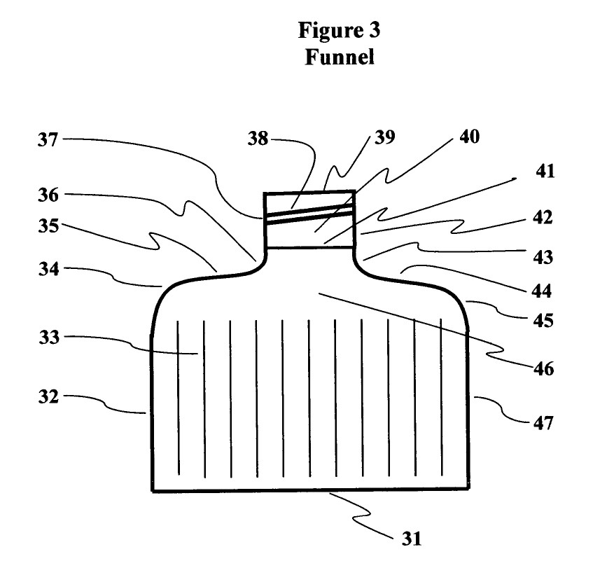

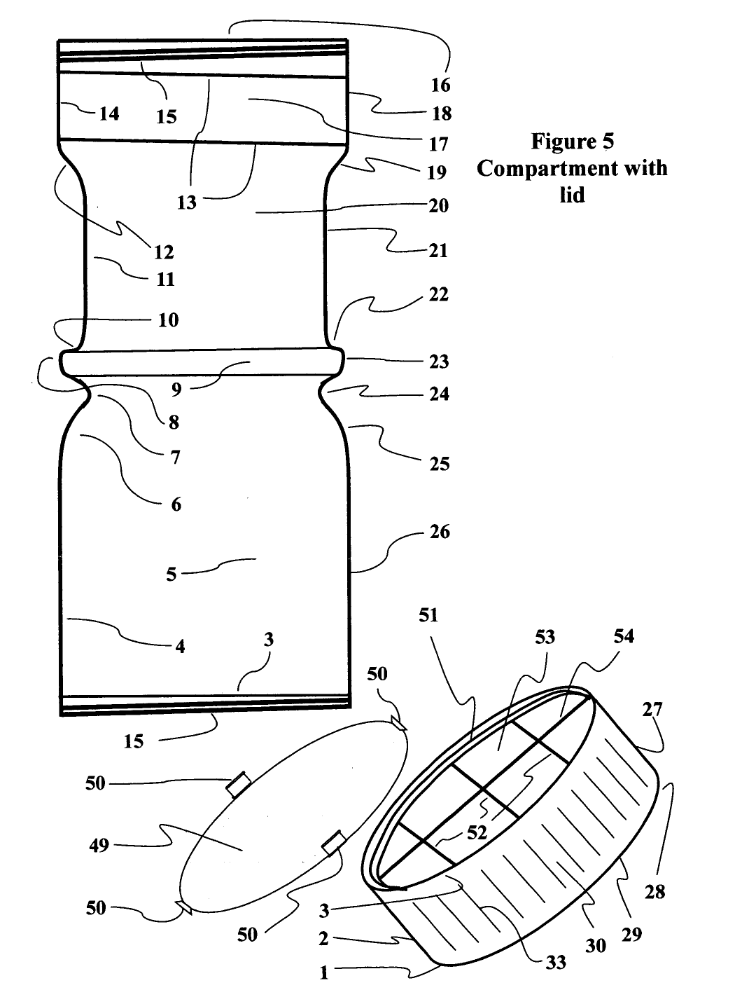

The preferred embodiment of the detachable bottle of the invention is illustrated in FIG. 1 (enclosed detachable bottle), FIG. 2 (Main body), FIG. 3 (Funnel), and FIG. 5 (Compartment). The detachable plastic molded bottle is a three-piece cylindrical shape that has a capability of opening the top portion of the bottle (46) allowing solid contents pouring into the main body (5). The third piece is located at the base (30) allowing storing of small contents such like medical pills or liquid into the compartment. The main body has a radial convex horizontal section (8) with an inward and outward curval slopes (6, 25) at the mid portion wall of the cylindrical main body. From the mid portion, it carries a straight cylindrical shape (11, 21) and connects to the outward curval slopes (12, 19) and finally straight cylindrical surface to the top (14, 18). The top neck of the main body (16) has two or three external convex slanted horizontal grooves (15) that attach to the funnel (46) by twisting clockwise until it is tightly secured. Just below the external convex slanted horizontal grooves, are two thick external horizontal grooves (13) that prevent funnel from over tightening and give strength to the body avoiding buckling.

The base of the main body (30) is another piece that is removable by twisting clockwise loosening the compartment shown in FIG. 5. The compartment has a cylindrical shape with approximately one inch in height; inside are four lines intersecting (52, 54) each other. Within the compartment, a cylindrical disc (49) with tabs (50) sits on top of compartment. Its purpose is to protect contents from spilling or fallen out of compartment. This allows storing of pills/capsules such like vitamins and medications. The compartment adds strength and rigidity to the bottle handling severe falls and banging against rigid objects.

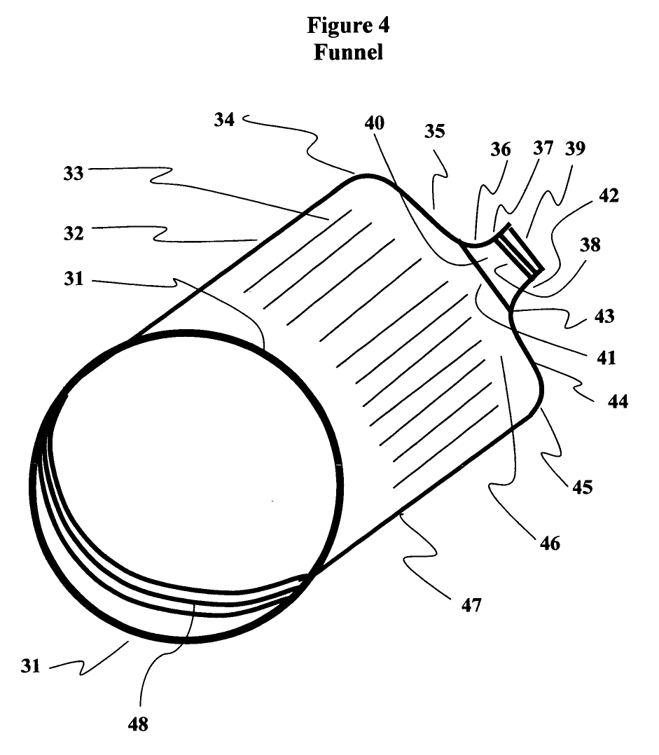

The remainder piece is a funnel shape, shown in FIG. 3, that is placed on top of the main bottle (16) by twisting clockwise until tightens. The funnel has two open ends (31, 39) where one is to attach the main body (17) and the other is for receptacle caps (66) for enclosure and drinking purposes. The bottom portion is a wide cylindrical surface (31) running straight toward the top and connects with inward curval slopes (34, 35. 43, 44), and finally straight into the small cylindrical shape (37, 41) with two external convex horizontal grooves (38). The top portion, just below the two external grooves, has an external wedge (41) for enclosure wall to protect the receptacle from over tightens. The bottom funnel has two or three internal horizontal concave grooves, see FIG. 4, (48) which permit screwing clockwise onto the main body. The exterior cylindrical body surface has multiple external vertical grooves (33) delivering maximum gripping.

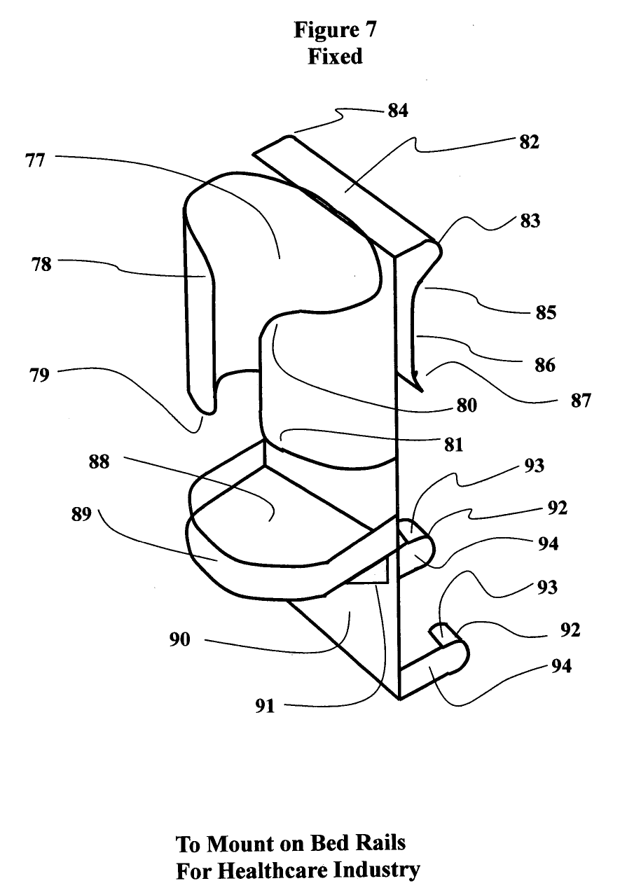

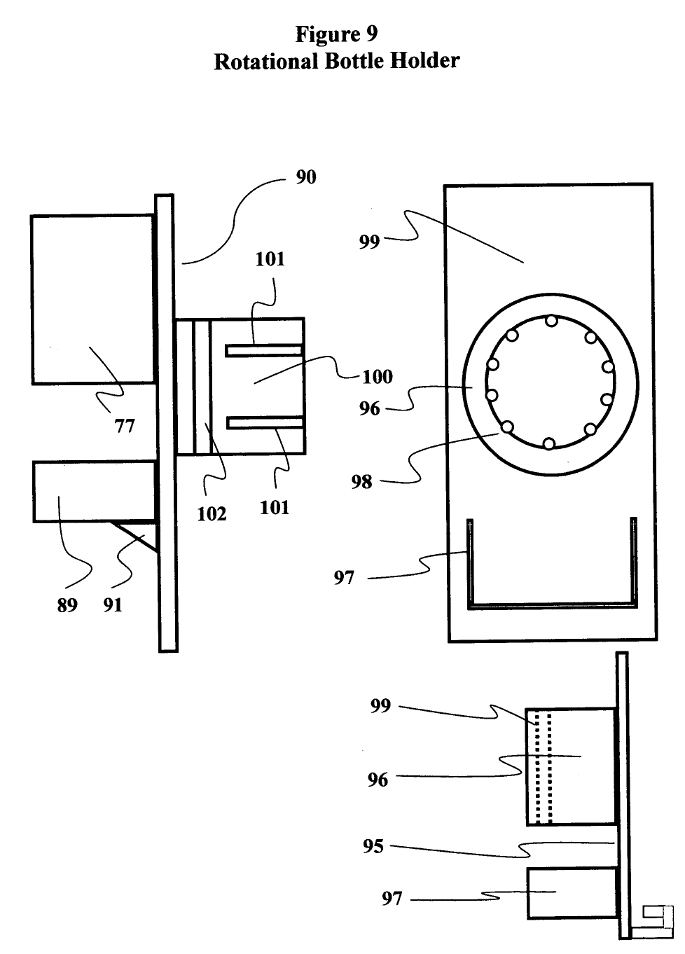

The bottle holder for healthcare shown in FIGS. 7 to 9 comprises a rectangular shape object with a base plate at bottom portion and a shell shape (73) at front portion of rectangular wall (90). The back of rectangular wall connects with a wide band (82) that curves outward (83, 84) and cuts back in and travels straight down (86) toward and close to the bottom back wall (87). Its purposes is to clamp over bed rails giving weight support of the plastic bottle containing liquid allowing bottle seating perpendicular to floor preventing from falling out of hospital bed, and for patient's easy access.

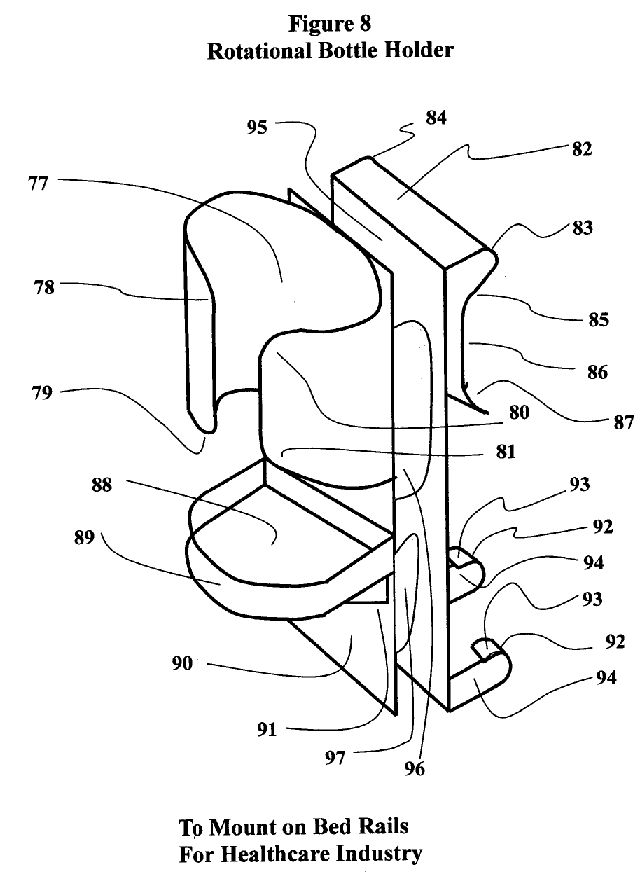

FIG. 8 shows the dual rectangular walls (90, 95) that are parallel to each other. Between the two walls is a circular flat knob forming two walls to unite. The first rectangular wall (90) contains a base plate (88, 89), a shell shape (77), and a circular flat knob with a nose (100). The base plate has a wedge (97) underneath to support bottle weight from tilting. The nose contains 4 external horizontal convex grooves (101) and a vertical external convex groove (102) that slides into the doughnut hole (96) that connects to front of second rectangular wall (95). The second rectangular wall has a circular flat knob with a doughnut hole (96) where the interior has ten horizontal convex grooves (98) and a circular concave groove (99) toward the inner end of the knob. A wide band connects at the rear second rectangular wall that allows clipping over hospital bed rails. This bottle holder provides a rotational position from 0 degrees to 360 degrees for convenient bottling arrangement until tilts to patient's comfortable angle. The second rectangular front wall has a long and continuous external convex groove (97) surrounding the knob providing weight support when the bottle holder is shifting or tilting position to patient's convenient level.

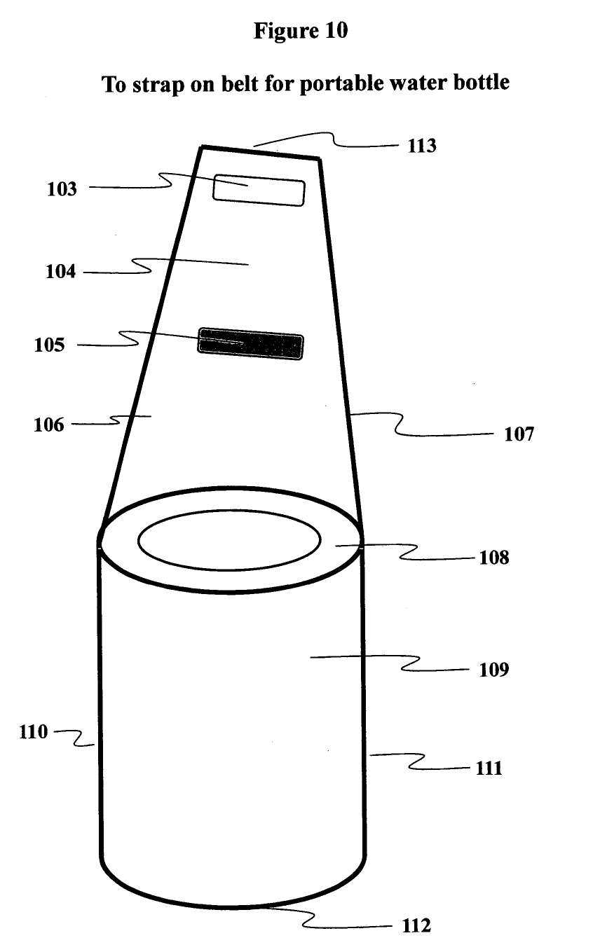

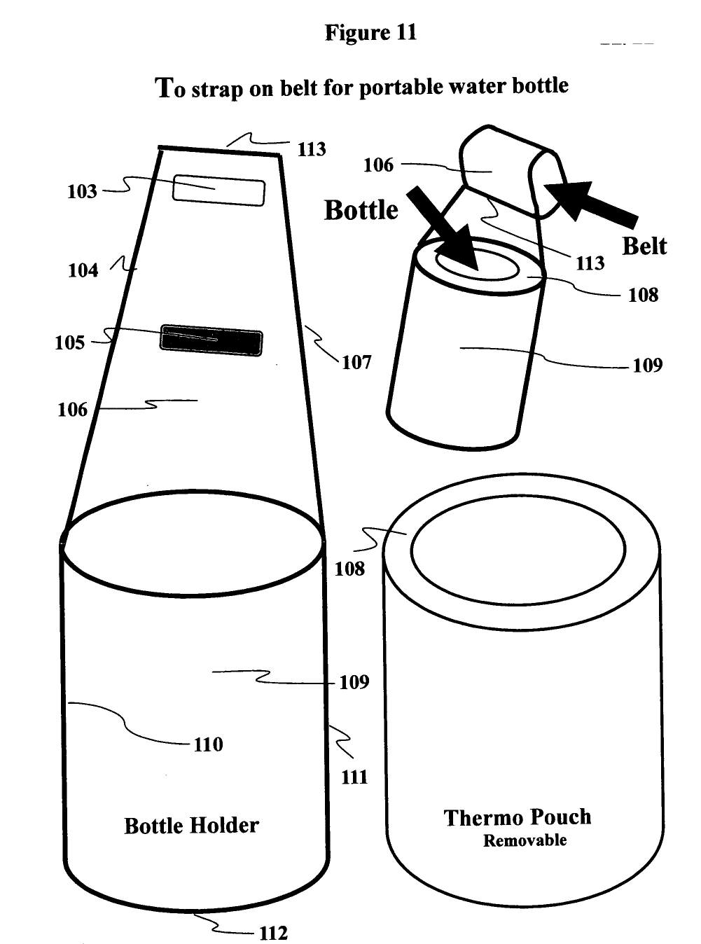

The bottle holder depicts in FIGS. 10 and 11 are the portable thermo pocket bag with belt strap allowing plastic bottle to be seated in the pocket for consumers. The consumer bottle holder has the taper shape strap (106) to hold bottle and wrap around belt or handbag for hands free carrying purpose. The thermo pouch (108) is removable from the bottle holder (109) allowing consumers to place drinking bottle in thermo pouch and store in handbags or place on top of a table.

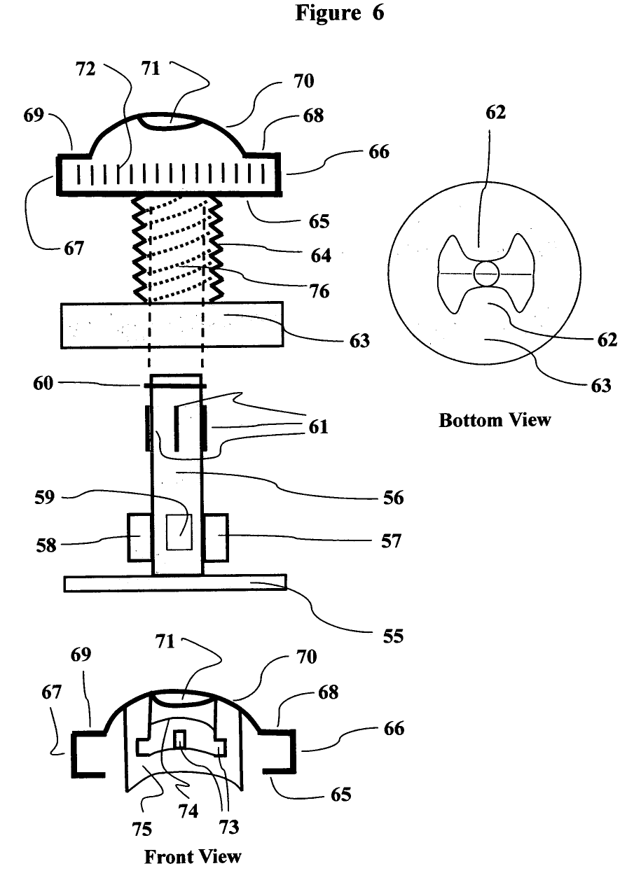

FIG. 6 is the mouth-drinking device that has a cylindrical shape at bottom portion (63) and elongated tip with a hole (70, 71) in a center at top portion of the device allowing fluids to pass through from a drinking bottle. The mechanism has two notches (57, 58) on each side of the shaft (56) allowing locking in an open or close position (62). To permanent close the mouth-drinking device, simply twist clockwise the lip surface (66, 67, 70) until notches latch on top plate (62) of the device. The top plate has a wedge indicating lock position. To have a permanent open position, simply press down and twist clockwise until lock; underneath a plate of the mouth drinking device has a wedge indicating lock position. The spout has a spring (76) surround the shaft between lip surface and bottom closure allowing shaft to pop up when pressed down by a human lips. When releasing the spout, it pops up and averts fluids flowing externally. Overall, the mouth-drinking device has four positions for opening and closing a spout.

### CONCLUSIONS, RAMIFICATIONS, AND SCOPE

Accordingly, the reader can visualize the detachable plastic bottle, bottle holder, and mouth-drinking receptacle invention can be beneficial to consumers and healthcare patients. It delivers consumers' and healthcare's productivity, convenience, and added values such like
a) Add large solid contents into bottle more easily, and quickly,
b) Can come in any portable size to provide convenience for all ages. It is suggested for the following size: 8 ounces (Half pint), 12 ounces, 16 ounces (One Pint), 24 ounces, 33.7 ounces (One Liter)
c) Children and working persons placed a small bottle (8 or 12) in lunch box serving ice water or juice
d) Individuals carry detachable bottle in a portable bottle holder or thermo pouch in handbag to quench thirst or need taking medication at their convenience
e) Personalize dietary meal program for lunch like chicken salad with dressing in compartment, and fruit salad and mixed nuts in detachable plastic bottle.
f) Persons carry any size bottle for traveling, hiking, working environment
g) It is reusable as often to refill ice water or solid contents at their convenience.
h) Can drink liquid from bottle more easily.

These bottles can be applicable to healthcare industry and hospice patients. Many patients do not have energy to lift heads or bodies to a suitable position to drink any form of liquid comfortably. Bottle holder clamps over bed rails bring easy access and convenience to drink liquid. There are two types of healthcare bottle holder, a simple fixture and the other is rotational capable of pivoting from 0 to 360 degrees (incrementing by 10 to 15 degrees). This would allow the water bottle to comfortably sit in bottle holder perpendicular to the floor when a headboard inclines to a suitable and comfortable position. In addition this averts water spillage on bed or floor, and increase nurses and medical staffs productivity. Patients will now have plastic water bottle day and night on bed rails.

The press-down and pop-up receptacle can be comfortable and convenience for any person of all ages to drink fluent hand free by pressing lip on the mouth-drinking spout. It is especially convenience for hospice patients who do not have strength to open and close conventional spout.

1. The method of joining three pieces of material together at their edges comprising the following steps of:
a) Providing said that three piece of material and positioning them together so that the top piece (46) shown in FIG. 3 overlaps an adjacent inner edge portion of the body piece (5) shown in FIG. 2 and
b) Bottom piece (30) of material is twisted until contact made to the bottom portion of body piece (3) of material whereby said form piece of material a single unit shown in FIG. 1.

2. In the claim 1, wherein said three piece of material is composed of PolyEthylene Terephthalate (PET) or High Density PolyEthylene (HDPE) form in any portable size.

3. In the claim 1, wherein said top piece is cylindrical shape with external vertical convex grooves (33) surround the shape means for easy hand twisting and tightening, inward slopes (34, 35, 44, 45) connect to narrow neck (40) with external horizontal and slanted convex grooves (38), and internal horizontal and slanted concave grooves at bottom cylindrical shape (48).

4. In the claim 1, wherein said body piece is cylindrical shape (5) with inward and outward slopes (6,7,10,12,19,22,24,25) whereby said body piece has external horizontal and slanted convex grooves (15) close to edge of body piece's neck (17), external horizontal radial medium wide convex grooves (9), external horizontal convex wedge close to neck (13), and the bottom base whereby said a bottom piece (30) attach to body piece.

5. In the claim 1, wherein said bottom piece is cylindrical shape with depth pocket containing grooves intersecting each other (52, 54).

6. In claim 2 said material form a rectangular shape (90, 95) with base plate (88), shell shape plate (77) with wide band (82) in back of rectangular wall.

7. In claim 6 said rectangular shape having two rectangular walls (90, 95) whereby one wall has flat circular doughnut hole knob (96, 100) with interior convex grooves (101) and concave groove, and other wall has flat circular knob with nose, horizontal convex grooves and a vertical convex groove.

8. In claim 2, wherein said material form a bottle holder with taper strap wall and separate pouch.

9. In claim 8, wherein said bottle holder has separate pouch is removable from bottle holder.

10. In claim 2, whereby said a spout piece with elongate shape at top portion whereas elongate shape connect a shaft with two notches and five convex grooves, a spring, and closure cylindrical shape with concave grooves.
